(19) United States
(12) Patent Application Publication
(10) Pub. No.: US 2005/0062563 A1
(43) Pub. Date: Mar. 24, 2005

(54) Circuit arrangement for operating electric or electronic components in a motor vehicle having an electric system comprising two voltages

(76) Inventors: Andreas Grundl, Munchen (DE); Bernhard Hoffmann, Starnberg (DE)

Correspondence Address: KEVIN FARRELL;PIERCE ATWOOD, ONE NEW HAMPSHIRE AVENUE, PORTSMOUTH, NH, 03801, US

(21) Appl. No.: 10/221,980

(22) PCT Filed: Mar. 8, 2001
(86) PCT No.: PCT/EP01/02623

(30) Foreign Application Priority Data
Mar. 17, 2000 (DE) 100 13 459.9

(51) Int. Cl. H01H 1/00

(52) U.S. Cl. 335/2

(57) ABSTRACT

The invention relates to a circuit arrangement for operating electric or electronic components in a motor vehicle with a two-voltage onboard network, with a direct current/direct current converter which comprises at least one input terminal, at least one output terminal and one ground terminal, with the input terminal being adapted to receive an input switching signal between a first voltage level and a ground level, and the output terminal being adapted to emit an output switching signal between a second voltage level, different from the first voltage level, and the ground level, the signal characteristic of which essentially follows the characteristic of the input switching signal, with the voltage converter with its input, output, and ground terminals being arranged in a housing which comprises a socket and which corresponds to a relay with respect to the dimensions and the positions of the input, output, and ground terminals at the socket.

### BACKGROUND OF THE INVENTION

The invention relates to a circuit arrangement for the operation of electric or electronic components in a motor vehicle with a two-voltage onboard network.

In the field of motor vehicles, relays are employed which are of compact construction, reliable function, and robustness. In particular, relays with corresponding housing dimensions and pin assignments are employed in motor vehicles, with the relays being normally inserted in plug-in sockets, in order to be easily replaceable for remedial purposes.

In the following, the terms “direct current/direct current converter” and “direct voltage/direct voltage converter” will be used as synonyms in the sense of a dc/dc converter, in which an input voltage of a first level is converted to an output voltage of a second level.

### STATE OF THE ART

Due to the increasing electrification of motor vehicles, in particular of passenger motor vehicles, where an ever increasing power has to be made available for electric loads, the development is heading towards the introduction of a second onboard network with a higher voltage (e.g. 42 V) in addition to the currently most commonly used 12 V onboard network. This, however, has the consequence that the cabling expenditure increases considerably, because both voltages must be available at virtually all sites in the motor vehicle.

Moreover, the quantity of loads with higher operating voltage, which has to be manufactured, is probably not as high as the number of loads with conventional operating voltage (12 V), so that the manufacturing costs of loads with higher operating voltage are relatively high. Thus, there is definitely a need to operate loads with the one operating voltage by means of drive signals with the other operating voltage. On the other hand, the line cross-section for supply lines to loads with low voltage and high current consumption is to be dimensioned relatively large so that the space requirement of the cable trees in the motor vehicle is higher with the low operating voltage (12-14 V) than with a higher operating voltage (42 V). The desire for a higher operating voltage (42 V) results from this circumstance.

DE 40 41 220 A1 describes a current supply for motor vehicles, wherein a voltage-regulated DC/DC converter arrangement at the input side at which the low voltage battery voltage is applied, maintains a medium voltage bus at a stabilised medium voltage. The medium voltage bus serves as the energy supply of loads which are to be operated by means of the medium voltage or by means of a high voltage. Medium voltage loads are immediately supplied with energy via the medium voltage bus, while high voltage loads each are supplied by a high voltage converter which is arranged between the DC/DC converter arrangement and the relevant load. The DC/DC converter arrangement, in particular, serves to transform low voltage onboard voltages for motor vehicles of approx. 12 V to a higher, stabilised, medium voltage of 150 V. The medium voltage applied to the medium voltage bus is brought up to the respective required high voltage between approx. 5 and 30 kV by the high voltage converters of conventional construction. DE 40 05 809 A1 discloses a regulator module with a standard relay or connector housing and a circuit arrangement disposed therein, whose connecting elements are routed out of the housing. The connecting elements are, in particular, arranged in accordance with a grid dimension specified for the standard housing and, especially, in accordance with a standard for automotive relays. In this manner it is possible to insert the regulator module into a standardised plug-in socket for relays. By a corresponding minor adaptation of the wiring of a relay which is generally arranged adjacent to the regulator module, said module can be driven be a regulated voltage. Hence, the regulator module is not used in order to replace a relay. The standardised plug-in socket is rather used for arranging the regulator module which serves to control one or several relays. Accordingly, it is necessary to provide a further plug-in socket adjacent to the plug-in sockets which are required for the existing relays, or to remove a relay in order to provide a free plug-in socket.

DE 44 19 005 A1 describes an electronic load interrupter switch for motor vehicles, where an electronic circuit-breaker and integrated drive electronics are arranged on a wiring carrier. External terminals of the wiring carrier are formed as a plug-in contact part typical for motor vehicles. In this manner it is possible to directly replace conventional electromechanical load interrupter switches by this circuit-breaker without requiring a modification of the external wiring of the load interrupter switch. If the drive electronics comprises an integrated clock generator, the load interrupter switch can be used as an electronic flasher unit. Parts of the wiring carrier can be formed as low-resistance resistors which serve for current monitoring and can have a current-limiting function. The load interrupter switch described therein merely serves as a replacement for conventional electromechanical load interrupter switches (relays), with the signals, currents, and voltages received and output by the load interrupter switch essentially corresponding to those of a relay to be replaced.

From DE 196 00 074 A1, a vehicle onboard network is known which in addition to the conventional onboard network voltage of approx. 12 V provides a further voltage for powerful electric loads. The higher voltage which can be up to four times the conventional onboard network voltage is generated by means of a parallel connection of several chopper stages. The supply of powerful electrical loads is effected in the conventional manner in that a power electronic circuit comprising the chopper stages is inserted between a vehicle battery and a generator of conventional construction, and this is connected conventionally with the loads by means of cable trees. In this manner the maximum current in the lines of the cable trees and, with the load output remaining constant, their ohmic losses are reduced, which is the reason why lines of smaller cross-section can be used.

### PROBLEMS ON WHICH THE INVENTION IS BASED

With this situation at hand, the invention is based on the problem to provide a possibility for reducing the wiring and connecting expenditure in motor vehicles with two-voltage onboard networks and to realise it by economic means.

### INVENTIVE SOLUTION

The inventive solution of this object consists in a circuit arrangement for operating electric or electronic components in a motor vehicle with a two-voltage onboard network, with a direct current/direct current converter which comprises at least one input terminal, at least one output terminal and one ground terminal, with the input terminal being adapted to receive an input switching signal between a first voltage level and a ground level, and the output terminal being adapted to emit an output switching signal between a second voltage level, different from the first voltage level, and the ground level, the signal characteristic of which essentially follows the characteristic of the input switching signal, with the voltage converter with its input, output, and ground terminals being arranged in a housing which comprises a socket and which corresponds to a relay with respect to the dimensions and the positions of the input, output, and ground terminals at the socket.

### ADVANTAGES OF THE INVENTION

This embodiment essentially allows to maintain the previously used wiring or cabling, respectively, of the motor vehicle electric/electronic system also in the case of vehicles with a two-voltage onboard network. The space requirement is virtually the same because in the previously used wiring or cabling, respectively, of the motor vehicle electric/electronic system relays are also provided between the respective switching element (e.g. on/off switch for the rear window heater). Usually, the relays of the motor vehicle electric/electronic system of a function group (starter; lighting, signalling system; blower, ventilation, heater; distributor injection pump, etc.) are combined and arranged in a close spatial relationship to one another. The invention makes it possible to employ externally (dimensions, pin assignment, etc.) corresponding components instead of the previous relays, which effect a voltage conversion to the respective voltage level. Another advantage is that trouble shooting and maintenance of a motor vehicle electric/electronic system equipped with such circuit arrangements are particularly simple because they are carried out in the same way as the replacement of relays inserted in sockets.

### ADVANTAGEOUS DEVELOPMENTS OF THE INVENTION

In a first embodiment of the invention the direct current/direct current converter is adapted to convert a voltage of approx. 12-14 V, which is applied at the input terminal to a voltage of approx. 42 V, which is provided at the output terminal.

In a second embodiment of the invention the direct current/direct current converter is adapted to convert a voltage of approx. 42 V, which is applied at the input terminal to a voltage of approx. 12-14 V, which is provided at the output terminal.

In an embodiment of the invention, the converter circuit which is required for this comprises an oscillator which can be switched on and off with an oscillation frequency of approx. 20 kHz to at least approx. 2 MHz, and a power output stage coupled with the oscillator's output, downstream of which a rectifier is connected. A transformer can be connected either upstream or downstream of the power output stage, if an electrical isolation is deemed to be necessary. In this case, however, it is preferred that the input side of the power output stage is connected with the secondary side of the transformer because then the power need not be transferred via the transformer so that this can be implemented with a small size. In embodiments with a common ground potential, however, no electrical isolation takes place so that the transformer is omitted.

If the electrical power fed into the input terminal of the circuit arrangement is not sufficient for providing the power required for the respective load at the output terminal, a supply voltage terminal for a supply voltage (approx. 12-14 V or approx. 42 V, respectively) which corresponds to the level of the input switching signal is provided in an embodiment of the inventive circuit arrangement. This voltage is then converted by the converter circuit to the respective other voltage level and provided at the output terminal in accordance with the characteristic of the voltage at the input terminal.

In an embodiment of the invention the power semiconductor devices are arranged in a heat conductive contact with inductive components of the direct current/direct current converter, containing iron, in order to avoid separate heat sinks for the power semiconductor devices. As inductive components containing iron, transformers, reactors, or other inductive coupling elements provided with one or several windings and made from iron sheet or from ferrite or the like are taken into consideration. In this way, the relatively voluminous iron body of, for example, a reactor or a transformer at the same time has as second function that of a heat dissipating element. In particular for applications with relatively short-time loading (e.g. flasher lamp, stop lamp, audible signalling device or the like) this provides an opportunity for very compact circuit arrangements with a relatively high power.

In a preferred embodiment of the invention the use of a printed board or card (printed circuit) is dispensed with, also for the sake of volume saving. Electric components of the direct current/direct current converter are electrically and mechanically connected with each other via load-carrying lines instead. In order to still realise an adequate mechanical strength and insusceptibility against external influences (moisture, condensed water, dust, etc.), the entire circuit is additionally encapsulated with a synthetic resin.

According to a preferred embodiment of the invention a direct current/direct current converter for use in the above described circuit arrangement comprises at least two half-bridge circuits formed by two semiconductor devices connected in series, wherein the respective two power semiconductor devices are connected with a control circuit which is adapted to connect the two power semiconductor forward and reverse in an antiphase manner, with a first terminal of an inductor being connected electrically conductive with the centre of each half-bridge circuit, second terminals each of the inductors being connected electrically conductive with each other, and the inductors being connected magnetically conductive with each other by a magnetic coupling element, and with the control circuit being adapted to drive the half-bridge circuits in such a manner that voltage is applied to only one of the inductors.

With this circuit a predetermined number n half-bridge circuits is connected with the control circuit and with the centre of each half-bridge circuit a first terminal of a predetermined number n inductors is connected electrically conductive and the second terminals of each inductor are connected electrically conductive with each other, with the magnetic coupling element being preferably a ferrite-containing component which couples the n inductors with each other.

Provided the number of the half-bridge arrangements or the inductors, respectively, in the magnetic coupling element equals the transmission ratio of the input to the output voltage, virtually no filter elements or the like are required for smoothing the voltage. For the reduction of possibly occurring voltage peaks, however, another inductor may be connected in series at the electrical connection point of the second terminals of the inductors.

For further smoothing and for the compensation of load variations an additional smoothing capacitor each can be arranged at the terminal parallel to the half-bridge arrangements and at the terminal remote from the half-bridge arrangements of the inductors or the further inductor, respectively.

Further properties, characteristics, advantages, and possible modifications of the invention will become apparent from the following description of the drawing in which embodiments of the invention are illustrated.

### BRIEF DESCRIPTION OF THE DRAWING

FIG. 1 shows a schematic illustration of a circuit arrangement of a relay in a two-voltage onboard network in a conventional circuitry.

FIG. 2 shows a schematic illustration of a circuit arrangement of a relay in a two-voltage onboard network according to the invention.

FIG. 3 shows a schematic illustration of a circuit arrangement of a voltage converter for an inventive circuit arrangement according to FIG. 2.

FIG. 4a shows a schematic side view of a magnetic coupling element with three inductors for the circuit arrangement according to FIG. 3.

FIG. 4b shows a schematic plan view of the magnetic coupling element according to FIG. 4a.

FIG. 5 shows a schematic characteristic of drive signals for the circuit arrangement of the voltage converter according to FIG. 3.

### DETAILED DESCRIPTION OF THE DRAWING

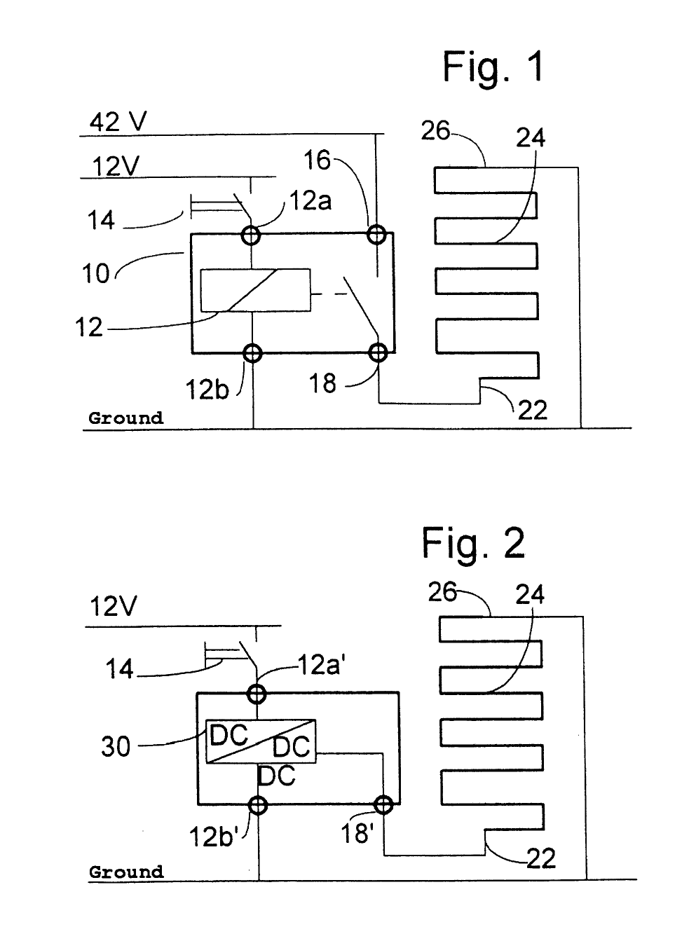

FIG. 1 is a schematic representation of a circuit arrangement of a relay 10 of a two-voltage onboard network. In the relay 10, its first terminal 12a of a coil 12 is connected with a first voltage of a lower level (approx. 12-14 V) via an on/off switch 14, and its second terminal 12b of the coil 12 is connected with ground. A third terminal 16 and a fourth terminal 18 of the relay 10 are respectively connected with a normally open switching element 20 whose contact is closed in the operating condition of the relay 10 and is opened in the rest condition of the relay 10.

It is understood that in lieu of the illustrated normally open switching element 20 normally closed, two-way contact elements with neutral position, or multiple contact elements can also be included in the relay 10.

The third terminal 16 of the relay 10 is connected with a second voltage which has a higher level (approx. 42 V), while its fourth terminal 18 is connected with a first terminal 22 of a load 24. A second terminal 26 of the load 24 is connected with ground.

Upon an operation of the on/off switch 14 current flows through the coil 12 of the relay 10 so that the normally open switch element 20 changes from its open to its closed position and the load 24 is connected with the second voltage which has a higher level (approx. 42 V).

In FIG. 2 an embodiment of the invention is schematically shown, where in a housing with the same dimensions, properties, and pin assignments or terminal layout, respectively, etc. as those of the relay 10 in FIG. 1 a direct current/direct current converter 30 is arranged which comprises an input terminal 12a′, an output terminal 18′, and a ground terminal 12b′. The first terminal 12a′ leads to an input of the direct current/direct current converter 30 and is connected with a first voltage with a lower level (approx. 12-14V) via an on/off switch 14′.

The second terminal 12b′ is the ground terminal of the direct current/direct current converter 30 and is connected with ground in the same manner as the terminal 12b in FIG. 1.

At the output terminal 18′ of the direct current/direct current converter 30 it provides an output voltage with the on/off switch 14′ operated, which—against ground—lies on a higher lever (e.g. 42 V) than the first voltage with a lower level (approx. 12-14 V).

For direct current/direct current converters 30, in particular, where the output at the output terminal 18′ is to be higher than the input power at the input terminal 12a′, the direct current/direct current converter 30 in an embodiment of the invention which is not illustrated is provided with an additional supply voltage terminal for a supply voltage (approx. 12-14 V or approx. 42 V, respectively) corresponding to the input switching signal.

Without discussing further details of the circuit arrangement already here, the power semiconductor devices of the direct current/direct current converter 30 in an embodiment are arranged in heat conductive contact with iron containing inductive components of the direct current/direct current converter.

For purposes of space/volume saving, the electronic components of the direct current/direct current converter 30 in the inventive circuit arrangement are connected with each other both electrically and mechanically via load-carrying lines.

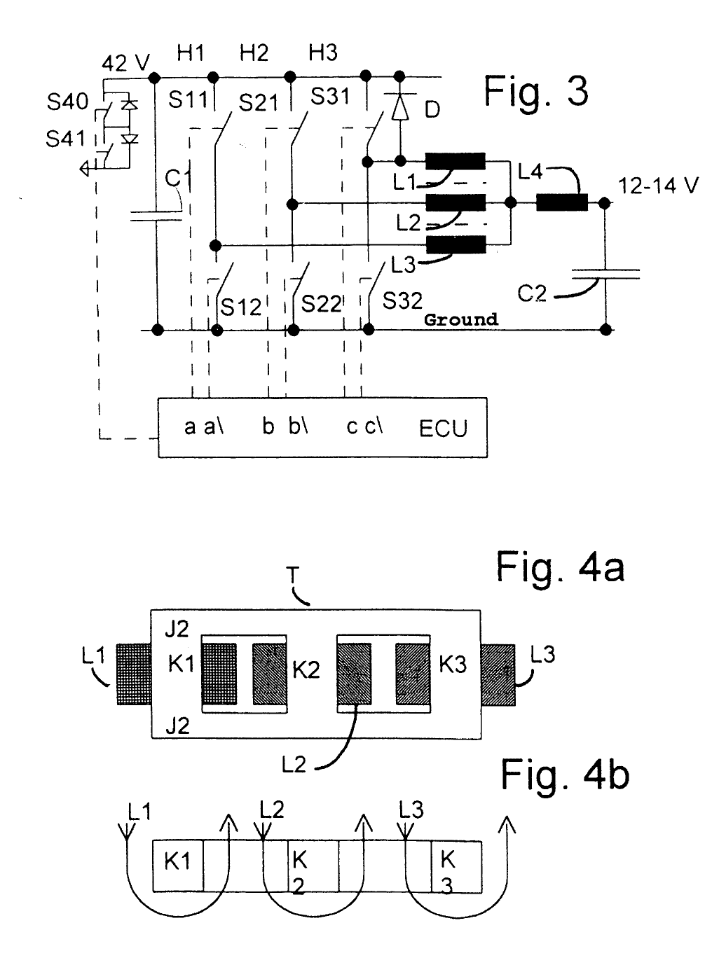

FIG. 3 is a schematic representation of a circuit arrangement of a voltage converter for an inventive circuit arrangement according to FIG. 2, wherein a voltage with a lower level (approx. 12-14 V) is applied at the input side, while at the output side a voltage with a higher level (approx. 42 V) is provided by this inventive circuit arrangement.

The circuit arrangement as specified herein has been described in conjunction with the application of the invention according to FIG. 2. It is, however, also possible to use this circuit arrangement, if required, with higher input power or output, respectively, so as to be advantageous for other purposes or fields of application.

At the input side of the inventive circuit arrangement a direct voltage of 12-14 V is applied. This direct voltage is applied in parallel at the three inductors L1, L2, L3 whose input side terminals are connected with each other. These inductors L1, L2, L3 are of identical inductance (L1=L2=L3) and are connected with each other magnetically conducting by a magnetic coupling element T (see FIGS. 4a, 4b). The magnetic coupling element T is a ferrite containing component which couples the three inductors L1, L2, L3 with each other.

The shown embodiment is a ferrite core with three legs K1, K2, K3 each of which being surrounded by one of the three inductors L1, L2, L3. At their respective faces, the three legs K1, K2, K3 are connected by one joke J1, J2 each (see FIGS. 4a, 4b). It is understood that the ferrite core as a whole can be an integral part or can be formed as an EI, M, or L-shaped iron core. This magnetic coupling element T acts as a hybrid transformer which does not store electric energy.

FIG. 4b also shows the sense of winding for the three inductors L1, L2, L3.

The inventive circuit arrangement comprises three half-bridges H1, H2, H3 connected in parallel, each of which being formed by two power semiconductor devices S11, S12; S21, S22; S31, S32 being connected in series between the output voltage (42 V) and ground. The power semiconductor devices are preferably power MOSFET's or IGBT's wherein one diode D each is additionally connected in parallel in the reverse direction (as shown by way of example for the power semiconductor device S31 only).

At the centre tap of each of the three half-bridges H1, H2, H3 the respective other terminal of one of the inductors L1, L2, L3 is connected.

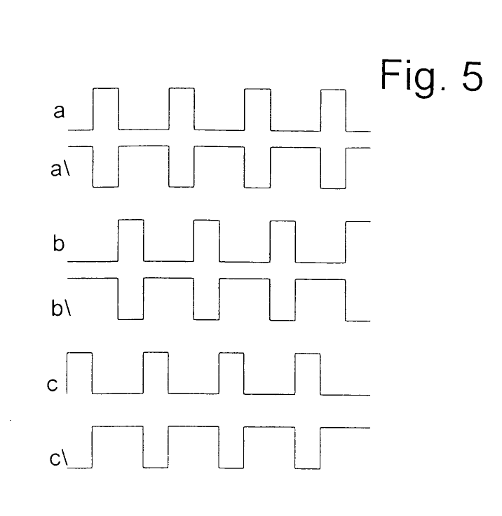

The three half-bridges H1, H2, H3 or the six power semiconductor devices S11, S12; S21, S22; S31, S32, respectively, of FIG. 3 are driven by an electronic control circuit ECU via six control lines a, a\; b, b\; c, c\ in such a manner that current flows off of only one of the three inductors L1, L2, L3 at a time. The magnetic coupling element T is thereby subjected to a complete magnetisation stroke so that no premagnetisation occurs. The characteristic of the drive signals on the six control lines a, a\; b, b\; c, c\ is illustrated in FIG. 5. The electronic control circuit ECU can be realised as a three-place shift register with inverted and non inverted outputs x, x\, through which a 1-0-0 sequence with a corresponding shift cycle passes. It must be ensured that the inverted and non inverted outputs x, x\ do not “overlap” in time. Rather a dead time (e.g. some 100 ns) which is adapted to the switching behaviour of the six power semiconductor devices S11, S12; S21, S22; S31, S32 must be maintained between the level changes with the inverted and the non inverted outputs x, x\.

In order to minimise voltage peaks at the output side of the circuit arrangement a further inductor L4 is provided which is connected in series with the three inductors L1, L2, L3 at the input side. In addition, at the output side in parallel to the half-bridge arrangements and at the terminal remote from the half-bridge arrangements of the further inductor L4, a smoothing capacitor C1 or C2, respectively, each can be arranged at the output side or at the input side, respectively.

In lieu of the illustrated three-phase embodiment of the circuit arrangement, it is also possible to utilise only one or two phases. In these cases, however, the expenditure for smoothing in order to achieve an essentially constant output voltage is higher.

As described above, the ferrite core can be used as a heat sink for the six power semiconductor devices S11, S12; S21, S22; S31, S32.

In the above described embodiment of the inventive circuit arrangement of the voltage converter, an input/output voltage ratio of 1:3 (14 V:42 V) is realised. This is obtained from the pulse duty factor of the drive signals on the six control lines a, a\; b, b\; c, c\.

The invention is, of course, not limited to the conversion ratio of 1:3. It is also possible to realise a higher or also a lower conversion ratio 1:n. In this case, the pulse duty factor (pulse:total time of a period) is also to be selected as 1:n. Moreover, it is recommended to also select an n-phase design of the circuit arrangement (n half-bridges with corresponding control lines from the electronic control circuit ECU, n inductors, etc.), in order to keep the above described expenditure for voltage smoothing small, or to realise a high voltage constancy at load changes, respectively.

Moreover, there is the possibility to realise a conversion ratio different from 1:n, where “gaps” occur between the individual pulses (see FIG. 5). This, however, requires a control circuit different from the above described control circuit ECU, in the form of the three-place circulating register with inverted and non-inverted outputs x, x\. In this case, the above described further inductance L4 and correspondingly dimensioned smoothing capacitors C1 or C2, respectively, are mandatory for energy storage.

In order to reliably isolate the output side (also in the case of a defect of one or several of the six power semiconductor devices S11, S12; S21, S22; S31, S32) from the input side, two further power semiconductor devices in the form of n-channel power MOSFET's S40, S41 are provided at the output side, which are connected in such a manner that their parasitic diodes D40, D41 are oriented against one another. These two power semiconductor devices S40, S41 are also driven by the control circuit ECU (with no input voltage applied) in such a manner that the input side is isolated from the output side.

1. A circuit arrangement for operating electric or electronic components in a motor vehicle with a two-voltage onboard network, with a direct current/direct current converter (30) which comprises at least one input terminal (12a′), at least one output terminal (18′) and one ground terminal (12b′), with the input terminal (12a′) being adapted to receive an input switching signal between a first voltage level and a ground level, and the output terminal (18′) being adapted to emit an output switching signal between a second voltage level, different from the first voltage level, and the ground level, the signal characteristic of which essentially follows the characteristic of the input switching signal, with the voltage converter with its input, output, and ground terminals being arranged in a housing (10) which comprises a socket and which corresponds to a relay with respect to the dimensions and the positions of the input, output, and ground terminals at the socket.

2. The circuit arrangement according to claim 1, wherein the direct current/direct current converter is adapted to convert a voltage of approx. 12-14 V, which is applied at the input terminal (12a′) to a voltage of approx. 42 V, which is provided at the output terminal (18′).

3. The circuit arrangement according to claim 1, wherein the direct current/direct current converter (30) is adapted to convert a voltage of approx. 42 V, which is applied at the input terminal (12a′) to a voltage of approx. 12-14 V, which is provided at the output terminal (18′).

4. The circuit arrangement according to claim 2 or 3, with a supply voltage terminal for a supply voltage (approx. 12-14 V or approx. 42 V, respectively) which corresponds to the level of the input switching signal.

5. The circuit arrangement according to claim 1, wherein one or each power semiconductor device of the direct current/direct current converter is arranged in a heat conductive contact with inductive components containing iron of the direct current/direct current converter.

6. The circuit arrangement according to claim 1, wherein electronic or electric components of the direct current/direct current converter are electrically and mechanically connected with each other via load-carrying lines.

7. The circuit arrangement according to one of the previous claims, wherein the direct current/direct current converter (30) comprises:
at least two half-bridge circuits (H1, H2, H3) formed by two semiconductor devices (S11, S12; S21, S22; S31, S32) connected in series, wherein the respective two power semiconductor devices (S11, S12; S21, S22; S31, S32) are connected with a control circuit (ECU) which is adapted to switch the two power semiconductor devices (S11, S12; S21, S22; S31, S32) to connect the two power semiconductor devices forward and reverse in an antiphase manner, with
a first terminal of an inductor (L1, L2, L3) being connected electrically conductive with the centre of each half-bridge circuit (H1, H2, H3),
second terminals each of the inductors (L1, L2, L3) being connected electrically conductive with each other, and
the inductors (L1, L2, L3) being connected magnetically conductive with each other by a magnetic coupling element (T), and with the control circuit (ECU) being adapted to drive the half-bridge circuits (H1, H2, H3) in such a manner that voltage is applied to only one of the inductors (L1, L2, L3).

8. The circuit arrangement according to claim 7, in whose direct current/direct current converter (30)
a predetermined number n half-bridge circuits (H1, H2, H3) is connected with the control circuit (ECU) and with the centre of each half-bridge circuit (H1, H2, H3) a first terminal of one of a predetermined number n inductors (L1, L2, L3) is connected electrically conductive, and the second terminals of each inductor (L1, L2, L3) are connected electrically conductive with each other, with the magnetic coupling element (T) being preferably a ferrite-containing component which couples the n inductors (L1, L2, L3) with each other.

9. The circuit arrangement according to claim 7 or 8, in whose direct current/direct current converter (30) a further inductor (L4) is connected in series at the electric connecting point of the second terminals of the inductors (L1, L2, L3).

10. The circuit arrangement according to claim 7 or 9, in whose direct current/direct current converter (30) a smoothing capacitor (C1, C2) each is arranged in parallel to the half-bridge arrangements and at the terminal remote from the half-bridge arrangements of the inductors (L1, L2, L3) or of the further inductor (L4), respectively.
